(19) United States
(12) Patent Application Publication
(10) Pub. No.: US 2026/0154295 A1
(43) Pub. Date: Jun. 4, 2026

(54) Communication Board

(71) Applicant: Angela Lee Morris, Jacksoville, FL (US)

(72) Inventor: Angela Lee Morris, Jacksoville, FL (US)

(21) Appl. No.: 18/902,900

(22) Filed: Sep. 30, 2024

(51) Int. Cl. G06F 16/29; G06Q 30/0241; H04W 4/80

(52) U.S. Cl. CPC G06F 16/29; G06Q 30/0241; H04W 4/80

(57) ABSTRACT

This invention provides an integrated system for real-time vehicle logistics, management, and dynamic digital signage in controlled environments like warehouses. It combines GPS tracking, BLE proximity detection, and high-resolution surveillance to monitor vehicles, while rugged tablets display real-time operational instructions and advertisements for loaders and management. Using Quantum GIS for mapping, Apache Kafka for data streaming, and secure communication via TLS 1.3 and OAuth 2.0, the system enhances efficiency, reduces errors, and supports sustainability by eliminating physical signage waste. Additional revenue is generated through targeted ads, making it a versatile solution for modern logistics.

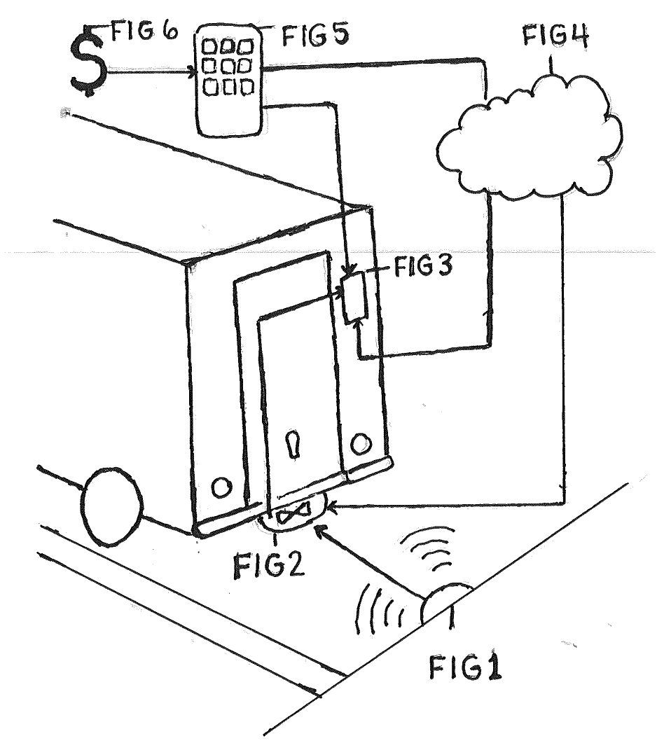

### STATEMENT REGARDING FEDERALLY SPONSORED RESEARCH OR DEVELOPMENT

Not Applicable

### BACKGROUND OF THE INVENTION

### Field of the Invention

This invention pertains to logistics and vehicle management in controlled environments like warehouses, where efficiency, safety, and communication are vital.

### DESCRIPTION OF THE RELATED ART

Traditional methods in warehouse logistics use paper or plastic signage for vehicle directions, safety alerts, and operational instructions, leading to substantial waste as signs are discarded daily or when outdated. This contributes to environmental concerns, such as deforestation and plastic pollution. Additionally, manual signage requires significant labor, is prone to errors (e.g., outdated instructions), and cannot adapt to real-time changes, causing inefficiencies, interdepartmental miscommunication, and increased operational costs. An effective solution should: (1) eliminate waste from disposable signage, (2) automate updates to reduce labor and errors, (3) enable real-time adaptability, (4) lower costs, and (5) improve coordination across departments. This would enhance operational efficiency and support sustainability goals.

### SUMMARY OF THE INVENTION

This invention provides a system for real-time vehicle logistics and dynamic digital signage in warehouses, replacing wasteful physical signage with a tablet mounted on each vehicle to display route information for loaders and management. The tablet receives the correct route information through one of two methods: (1) map surveillance using GPS and cameras to track the vehicle and upload route information when parked in an assigned parking space, or (2) interfacing with a Bluetooth Low Energy (BLE) device in the parking space to automatically provide route information. These methods can operate independently, serving as backups to ensure reliability—if one method fails (e.g., a BLE device malfunctions or the surveillance system is overloaded), the other can still provide the necessary route information. The invention is not limited to the specific devices mentioned herein, and other equivalent devices or technologies may be used to achieve the same functionality. The system eliminates physical signage waste, enhances safety with dynamic instructions, and improves efficiency through automation and interdepartmental coordination via a smartphone app. By replacing physical signage with a tablet, the system reduces the need for management to physically put up and take down signs, further minimizing labor and operational disruptions. Additionally, the system provides a time-saving bridge by automatically delivering the parking space's route information to the tablet on the back of the truck as soon as the vehicle is backed into the space, enabling loaders and management to access critical information immediately. Loaders can promptly identify the truck's assigned route or load details, while management can coordinate operations in real-time, enhancing workflow efficiency. In contrast, conventional methods require management to manually prepare and install signs, a process that includes determining the route, preparing the sign, and placing it at the designated space, typically requiring 3-5 minutes per parking space. This can accumulate to hours across a large warehouse while loaders await instructions, whereas the proposed system transmits the information in seconds, significantly reducing delays and improving operational efficiency for loaders and management. The tablet can also display instructions during road transit, and optionally show advertisements during idle periods, though the primary focus is on operational efficiency and sustainability.

### DETAILED DESCRIPTION OF THE INVENTION

### Overview

This system enhances warehouse logistics through real-time vehicle tracking and dynamic digital signage, featuring two embodiments with shared components to improve efficiency, safety, and sustainability. A tablet mounted on each vehicle replaces wasteful physical signage, displaying route information for loaders and management, delivered via two independent methods that serve as backups for reliability.

### Embodiment 1: GPS and Surveillance Integration

This embodiment tracks vehicles using: (1) Quantum GIS (QGIS) for facility mapping, (2) Trimble R9s GNSS receiver and Dell PowerEdge R740xd server for GPS data, (3) Axis P1448-LE cameras with NVIDIA DeepStream SDK and TensorFlow for surveillance, (4) Apache Kafka, Node. js, and PostgreSQL with PostGIS for data integration, (5) Firebase Cloud Messaging or APNs with TLS 1.3 for secure notifications, and (6) a rugged tablet with a touchscreen display and wireless connectivity displaying route details and load information via a mobile app for loaders and management. Upon vehicle entry, GPS and surveillance data update digital maps. When the vehicle parks in an assigned space, the system uploads route information to the tablet, ensuring accuracy. The tablet can also display instructions during road transit, and optionally show advertisements during idle periods, though the primary focus is on providing information for warehouse operations.

### Embodiment 2: BLE Proximity Logistics

This embodiment employs BLE beacons (iBeacon/Eddystone) at parking bays, a Bluetooth 5.2 module on vehicles, and the tablet for signage. As a vehicle approaches a bay, BLE establishes a secure MQTT connection, verifies the vehicle, and automatically provides route information (e.g., “Route 214,” “Proceed to Unload”) to the tablet based on location. For example, when a truck is backed up to a loading dock at parking space number 214, the rugged tablet mounted on the truck can display the route instruction “Route 214,” received via the BLE connection, allowing loaders to identify the truck's assigned route or load details and enabling management to coordinate operations accordingly. If the BLE device malfunctions, the GPS and surveillance method from Embodiment 1 can serve as a backup. Staff can override signage via the app, ensuring flexibility. OAuth 2.0 ensures secure access. The tablet can display instructions during transit, and optionally show advertisements during idle periods, though this is secondary. Benefits include reduced waste, real-time updates, improved safety, better coordination, and, by replacing physical signage with a tablet, a reduction in the need for management to physically put up and take down signs, further minimizing labor and operational disruptions. Additionally, the system provides a time-saving bridge by automatically delivering the parking space's route information to the tablet on the back of the truck as soon as the vehicle is backed into the space, enabling loaders and management to access critical information immediately. Loaders can promptly identify the truck's assigned route or load details, while management can coordinate operations in real-time, enhancing workflow efficiency. In contrast, conventional methods require management to manually prepare and install signs, a process that includes determining the route, preparing the sign, and placing it at the designated space, typically requiring 3-5 minutes per parking space. This can accumulate to hours across a large warehouse while loaders await instructions, whereas the proposed system transmits the information in seconds, significantly reducing delays and improving operational efficiency for loaders and management.

### Disclaimer

References to specific products or brands are for illustrative purposes only and do not limit the invention to those products. Equivalent devices or technologies may be used. The invention is not limited to the specific devices mentioned herein, and other equivalent devices or technologies may be used to achieve the same functionality.

1. An integrated system for real-time vehicle logistics, management, and dynamic digital signage, comprising:
a digital mapping system utilizing Quantum GIS (QGIS) with geotagging for spatial data management;
a GPS component with a Trimble R9s GNSS receiver for precise vehicle tracking;
a surveillance system with Axis P1448-LE cameras and NVIDIA DeepStream SDK for real-time video analytics;
a data integration server using Apache Kafka, Node.js, and PostgreSQL with PostGIS for processing vehicle data and digital maps;
a communication framework employing Firebase Cloud Messaging or APNs with TLS 1.3 encryption for secure notifications;
a rugged tablet mounted on vehicles to display operational instructions or advertisements, controlled via a mobile app.

2. The system of claim 1, further comprising a Bluetooth Low Energy (BLE) system for proximity logistics, wherein:
BLE beacons are installed at parking bays, supporting iBeacon or Eddystone protocols;
a vehicle Bluetooth module with Bluetooth 5.2 communicates with said beacons;
the rugged tablet displays location-specific instructions or advertisements via MQTT over BLE.

3. A method for vehicle logistics and signage management, comprising:
initiating GPS tracking upon vehicle entry into a managed area;
using surveillance to monitor vehicle actions such as parking or movement;
integrating GPS and surveillance data to update vehicle status on digital maps in real-time;
transmitting operational instructions or advertisements to the vehicle-mounted tablet via a secure mobile app interface.

4. The method of claim 3, wherein the dynamic signage feature includes:
displaying real-time instructions such as “Proceed to Unload” or “Route 214” on the tablet;
allowing manual control of instructions via the mobile app for interaction with personnel or vehicles.

5. The system of claim 1 or 2, wherein security features include:
TLS 1.3 for secure communications;
AES encryption for data at rest;
OAuth 2.0 for secure session management between the mobile app and tablet.

6. A system for interdepartmental coordination, wherein:
the rugged tablet integrates with the warehouse network to share real-time operational data across departments;
this integration improves transparency, reduces delays, and enhances efficiency.

7. A revenue-generating feature within the system, wherein:
the vehicle-mounted tablet displays context-relevant advertisements during idle periods, creating an additional revenue stream without disrupting operations.

8. The system or method of any preceding claim, wherein the advertisement feature is:
non-intrusive to operational instructions;
managed via the mobile app for curation and delivery based on vehicle location or activity.
